(19) United States
(12) Patent Application Publication
(10) Pub. No.: US 2012/0199714 A1
(43) Pub. Date: Aug. 9, 2012

(54) POT RACK HOOK

(76) Inventor: John Joseph Rinaldo, Chicago, IL (US)

(21) Appl. No.: 13/364,440

(22) Filed: Feb. 2, 2012

Related U.S. Application Data
(60) Provisional application No. 61/439,062, filed on Feb. 3, 2011.

(51) Int. Cl. F16B 45/00

(52) U.S. Cl. 248/304

(57) ABSTRACT

The novel hook of the present invention comprises a hook having a hook portion at one end for use in securing pots and pans and then extending axially to its opposite end wherein it has a C or U shaped bend and then extends down towards the hook portion while rotating about the axis of the hook.

### RELATED APPLICATIONS

This application claims the benefit the United States Provisional Application No. 61/439062, entitled “POT RACK HOOK” filed Feb. 3, 2011 filed by the same inventor, which is incorporated by reference in its entirety.

### FIELD OF INVENTION

This invention relates to improved hangers or hooks to be used with pot rack systems that are used for storing pots and pans and utensils.

### DESCRIPTION OF THE PRIOR ART

One major drawback in conventional pot rack systems resides in the area where the hook attaches to the metal rack. Conventional pot hangers sometimes include hooks at both ends which often times results in the removal of the hook from the metal rack when a user lifts a pot or pan. The hook or hanger therefore is not properly secured in the metal rack and can easily be removed or lifted out when a user attempts to lift a pan or pot or utensil. The present invention solves the shortcomings in conventional pot rack systems by providing a unique hook that can be used with conventional track arrangements which allows the hook to be secured into the rack and requires a 270 degree rotation of the hook to be removed from the rack. The hook remains firmly in place on the rack until the user desires to remove it. With no lock or tension unsecure to remove the hook from the pot rack system with just a simple twist. The system also requires no mechanism that snaps on or grips onto to pot rack that would scratch any part of the pot rack system. The present invention is also universal to all pot racks with wire, grid or rod type system.

### SUMMARY OF THE INVENTION

The novel hook of the present invention comprises a hook having a hook portion at one end for use in securing pots, pans, and utensils and then extending axially to its opposite end wherein it has a C or U shaped bend and then extends down towards the hook portion while rotating about the axis of the hook. The portion of the hook that rotates about its axis allows the user to secure the hook on to a metal rod of a pot rack system by rotating the hook and sliding the hook on to the metal rod until the bottom of the C or U shaped bend lies upon the metal rod of the pot rack system. The spiral of the rotating portion prevents the inadvertent removal of the hook from the pot rack system.

The present invention can also be used for any items that need to be hung or stored including hanging flower pots, lights, bicycles, garden tools etc.

### BRIEF DESCRIPTION OF THE DRAWINGS

FIG. 1 is a perspective view of an embodiment of the pot rack hook of the present invention.

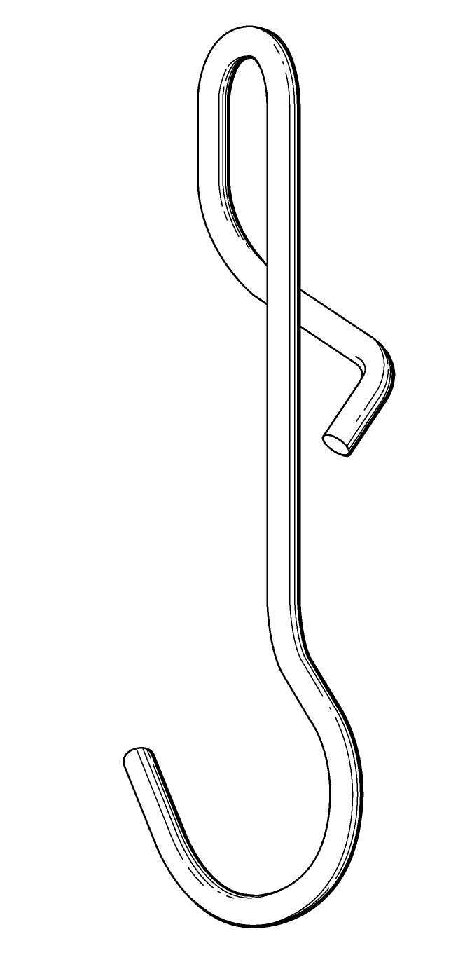

### DETAILED DESCRIPTION OF THE INVENTION

The present invention comprises a hook having a hook portion at one end for use in securing pots and pans and then extending axially to its opposite end wherein it has a C or U shaped bend and then extends down towards the hook portion while rotating about the axis of the hook. The portion of the hook that rotates about its axis allows the user to secure the hook on to a metal rod of a pot rack system by rotating the hook and sliding the hook on to the metal rod until the bottom of the C or U shaped bend lies upon the metal rod of the pot rack system. The spiral of the rotating portion prevents the inadvertent removal of the hook from the pot rack system.

In a preferred embodiment, the rotating portion. In another embodiment, the rotating portion of the hook may have multiple turns such that the rotating portion crosses the axis of the hook at multiple spots. In yet another embodiment, the portion of the hook between the hook portion and the C or U shaped bend may rotate about the axis of the hook as well such that the rotating portion and such portion parallel one another.

The unique hook is preferably are made from cast aluminum, polished stainless steel or chrome-plated carbon steel to provide an attractive high mirror polished finish. The hook may be constructed of any conventional material including rigid plastic or wood for economic and decorative purposes.

The present invention allows the hook to be secured into the rack and in a preferred embodiment requires at the minimum a 270 degree rotation of the hook to be removed from the rack. The hook remains firmly in place on the rack until the user desires to remove it. In the present invention, the greater the degree of rotation required to remove the hook from the rack, the greater the security of the hook remaining on the rack. Therefore, in a preferred embodiment, the rotating portion rotates about the axis in the range of greater than 270 degrees relative to the C or U bend of the hook.

The present invention may further have more than one hook portion to enable the user to store or hang multiple pots, pans or utensils.

The present invention may vary in length to enable the user to store or hang pots, pans or utensils of various sizes. The present invention may further be used to hang clothes such as dress shirts in closets and with closet organization systems. The novel hook may also be used with any garage organization system to hang tools or larger items such as bicycles. The present invention may be used with any wire grid, rod, or rack to hang or store a variety of items and is not limited to the uses discussed herein. The present invention may further be used with any single hook, single rod, bolt, nail, or any conventional hanging means to hang or store a variety of items and is not limited to the uses discussed herein.

Although the description above contains many specificities, these should not be construed as limiting the scope of the invention but as merely providing illustrations of some of the presently preferred embodiments of this invention.

I hereby claim:

1. A hook to be used with pot rack systems that are used for storing pots and pans comprising a hook having at least one portion that rotates about the axis of the hook.

2. A hook according to claim 1, wherein the hook has multiple portions that rotate about the axis of the hook.

3. A hook according to claim 1, wherein the at least one portion rotates about the axis of the hook in a range greater than 45 degrees relative to the axis of the hook.

4. A hook according to claim 1 wherein the hook is made of cast aluminum.

5. A hook according to claim 1 wherein the hook is made of polished stainless steel.

6. A hook according to claim 1 wherein the hook is made of chrome-plated carbon steel.

7. A hook according to claim 1 wherein the hook is made of a rigid plastic.

8. A hook according to claim 1 wherein the hook is made of wood or wood product.

9. A hook according to claim 1 wherein the hook requires at the minimum a 270 degree rotation of the hook to be removed from a pot rack.
